(19) United States
(12) Patent Application Publication
(10) Pub. No.: US 2024/0413343 A1
(43) Pub. Date: Dec. 12, 2024

(54) ELECTRODE AND BATTERY

(71) Applicant: Panasonic Intellectual Property Management Co., Ltd., Osaka (JP)

(72) Inventor: Honami SAKO, Osaka (JP)

(21) Appl. No.: 18/811,264

(22) Filed: Aug. 21, 2024

Related U.S. Application Data
(63) Continuation of application No. PCT/JP2023/005329, filed on Feb. 15, 2023.

(30) Foreign Application Priority Data
Feb. 28, 2022 (JP) 2022-030168

(51) Int. Cl. H01M 4/62; H01M 10/0562

(52) U.S. Cl. CPC H01M 4/625; H01M 10/0562; H01M 2300/008

(57) ABSTRACT

An electrode of the present disclosure includes an electrode active material, a solid electrolyte, and a conductive additive. The conductive additive includes a carbonaceous conductive material, and a coating film coating a surface of the carbonaceous conductive material. The coating film includes an electrically conductive polymer. A battery of the present disclosure includes a positive electrode, a negative electrode, and an electrolyte layer positioned between the positive electrode and the negative electrode. At least one selected from the group consisting of the positive electrode and the negative electrode is the electrode of the present disclosure. The electrolyte layer includes a solid electrolyte.

This application is a continuation of PCT/JP2023/005329 filed on Feb. 15, 2023, which claims foreign priority of Japanese Patent Application No. 2022-030168 filed on Feb. 28, 2022, the entire contents of both of which are incorporated herein by reference.

### BACKGROUND OF THE INVENTION

### 1. Field of the Invention

The present invention relates to an electrode and a battery.

### 2. Description of Related Art

JP 2011-100594 A discloses a lithium-ion battery including an electrode in which an electrically conductive polymer and a conductive additive are dispersed.

### SUMMARY OF THE INVENTION

The present disclosure aims to provide an electrode having a configuration suitable for reducing the electrode resistance.

An electrode of the present disclosure includes:
an electrode active material;
a solid electrolyte; and
a conductive additive, wherein
the conductive additive includes a carbonaceous conductive material and a coating film coating a surface of the carbonaceous conductive material, and
the coating film includes a conductive polymer.

The present disclosure can provide an electrode having a configuration suitable for reducing the electrode resistance.

### BRIEF DESCRIPTION OF THE DRAWINGS

FIG. 1 is a cross-sectional view showing an electrode 1000 according to Embodiment 1.

FIG. 2 is a cross-sectional view showing a battery 2000 according to Embodiment 2.

FIG. 3 is a cross-sectional view showing a battery 3000 according to Embodiment 3.

FIG. 4 is a graph showing charge-discharge cycle characteristics of batteries of Example and Comparative Example.

### DETAILED DESCRIPTION

(Findings on which the Present Disclosure is Based)

JP 2011-100594 A described in Description of Related Art discloses increasing the electron conductivity of an electrode of a lithium-ion battery by adding a conductive polymer to the electrode. JP 2011-100594 A describes that the presence of the conductive polymer in the electrode of the battery contributes to an increase of the number of electron conduction paths and therefore the electrode for lithium-ion batteries can have an increased electron conductivity. Additionally, the battery includes an electrolyte solution consisting of a lithium salt and a solvent as an electrolyte. Therefore, after formation of an electron conduction path, an ion conduction path is formed in the electrode by penetration of the ion conductive liquid.

On the other hand, in the case of a battery system, such as an all-solid-state lithium secondary battery, including a solid electrolyte, an electrode is produced by mixing its constituent materials, such as a solid electrolyte, a conductive additive, and an electrode active material. Therefore, an electron conduction path and an ion conduction path are formed simultaneously. In this case, since the materials are solid, a void tends to be formed between the materials. That is, a void formed in a portion of the electrode, for example, can obstruct either or both the electron conduction path and the ion conduction path in the electrode. This increases the resistance of the electrode, decreasing the discharge voltage of the battery. The energy density of the battery decreases if the conductive additive is increased in amount to complement the insufficient electron conductivity.

Therefore, the present inventor made intensive studies on the configuration of an electrode for reducing the resistance of the electrode. As a result, the present inventor found that the resistance of an electrode is reduced by coating a conductive additive with a conductive polymer. The term “conductive polymer” herein refers to, for example, a conductive polymer including a π-conjugated conductive polymer and a polyanion having at least one selected from the group consisting of a monosubstituted sulfate ester group, a monosubstituted phosphate ester group, a phosphate group, a carboxy group, and a sulfo group.

The present inventor confirmed that the resistance of an electrode can be decreased by producing the electrode using a conductive additive configured as described above (namely, a conductive additive having a surface coated with a conductive polymer) and consequently the discharge voltage of a battery including the electrode can be increased. Although details of the mechanism are unclear, it is thought that the coating film including the conductive polymer formed on the surface of the conductive additive and binding of particles of the conductive additive to each other increase a path length of an electron conduction path made of the conductive additive and thereby enhance the electron conductivity of the electrode. The present inventor also confirmed that these effects can be achieved even when the surface of the conductive additive is not completely coated with the conductive polymer. That is, even when a portion of the surface of the conductive additive is not coated with the conductive polymer, an electrode resistance decreasing effect and an increasing effect on the discharge voltage of a battery can be achieved.

Moreover, it is thought that an increase of the internal resistance of a battery at the interface between a conductive additive and a solid electrolyte during charging and discharging can also be reduced by producing an electrode using a conductive additive configured as described above (namely, a conductive additive having a surface coated with a conductive polymer). Because a potential change equivalent in magnitude to that in a solid active material occurs also at the surface of a conductive additive during charging and discharging, a side reaction involving electron exchange induced by a potential difference between the solid electrolyte and the conductive additive is likely to occur at the interface between the solid electrolyte and the conductive additive during charging and discharging. A product of this side reaction increases the resistance at the interface between the conductive additive and the solid electrolyte in many cases. Therefore, coating at least a portion of a conductive additive with a conductive polymer having semiconductor-like properties is advantageous in reducing the resistance because, by coating at least a portion of a conductive additive with a conductive polymer having semiconductor-like properties, both securing of electron conductivity and inhibition of the above side reaction can be achieved.

In light of the above findings, the present inventor has conceived the following electrode and batteries of the present disclosure.

### (Summary of One Aspect According to the Present Disclosure)

An electrode according to a first aspect of the present disclosure includes:
an electrode active material;
a solid electrolyte; and
a conductive additive, wherein
the conductive additive includes a carbonaceous conductive material and a coating film coating a surface of the carbonaceous conductive material, and
the coating film includes a conductive polymer.

The electrode according to the first aspect can enhance the ionic conductivity of the electrode and thereby can decrease the electrode resistance. That is, the electrode according to the first aspect has a configuration suitable for reducing the electrode resistance. Since the electrode according to the first aspect can decrease the electrode resistance, the electrode according to the first aspect can increase the discharge voltage of a battery including the electrode.

According to a second aspect, for example, in the electrode according to the first aspect, the conductive polymer may include a π-conjugated conductive polymer and a polyanion having at least one selected from the group consisting of a monosubstituted sulfate ester group, a monosubstituted phosphate ester group, a phosphate group, a carboxy group, and a sulfo group.

The electrode according to the second aspect can decrease the electrode resistance and thereby can increase the discharge voltage of a battery including the electrode.

According to a third aspect, for example, in the electrode according to the first or second aspect, the π-conjugated conductive polymer may include a homopolymer and/or a copolymer of at least one polymerizable compound selected from the group consisting of a thiophene, a pyrrole, an indole, a carbazole, an aniline, an acetylene, a furan, a paraphenylene vinylene, an azulene, a paraphenylene, a paraphenylene sulfide, an isothianaphthene, and a thiazyl, and the polyanion may include at least one selected from the group consisting of polyvinyl sulfonic acid, polystyrene sulfonic acid, polyallyl sulfonic acid, polyethyl acrylate sulfonic acid, polybutyl acrylate sulfonic acid, poly-2-acrylamido-2-methylpropanesulfonic acid, polyisoprene sulfonic acid, polyvinyl carboxylic acid, polystyrene carboxylic acid, polyallyl carboxylic acid, polyacrylic carboxylic acid, polymethacryl carboxylic acid, poly-2-acrylamide-2-methylpropanecarboxylic acid, polyisoprene carboxylic acid, and polyacrylic acid.

The electrode according to the third aspect can decrease the electrode resistance and thereby can increase the discharge voltage of a battery including the electrode.

According to a fourth aspect, for example, in the electrode according to the third aspect, the π-conjugated conductive polymer may include a homopolymer and/or a copolymer of at least one polymerizable compound selected from the group consisting of thiophene and a thiophene derivative, and the polyanion may include at least one selected from the group consisting of polyvinyl sulfonic acid, polystyrene sulfonic acid, polyallyl sulfonic acid, polyethyl acrylate sulfonic acid, polybutyl acrylate sulfonic acid, poly-2-acrylamido-2-methylpropanesulfonic acid, and polyisoprene sulfonic acid.

The electrode according to the fourth aspect can decrease the electrode resistance and thereby can increase the discharge voltage of a battery including the electrode.

According to a fifth aspect, for example, in the electrode according to any one of the first to fourth aspects, the carbonaceous conductive material may include a fibrous carbonaceous conductive material.

The electrode according to the fifth aspect can decrease the electrode resistance and thereby can increase the discharge voltage of a battery including the electrode.

According to a sixth aspect, for example, in the electrode according to the fifth aspect, the carbonaceous conductive material may include a fibrous carbonaceous conductive material having a fiber diameter of 0.1 nm or more and 200 nm or less.

The electrode according to the sixth aspect can decrease the electrode resistance and thereby can increase the discharge voltage of a battery including the electrode.

According to a seventh aspect, for example, in the electrode according to the sixth aspect, the fibrous carbonaceous conductive material may include a first fibrous carbonaceous conductive material having a fiber diameter of 80 nm or more and 200 nm or less.

The electrode according to the seventh aspect can decrease the electrode resistance and thereby can increase the discharge voltage of a battery including the electrode.

According to an eighth aspect, for example, the electrode according to the sixth or seventh aspect, the fibrous carbonaceous conductive material may include a second fibrous carbonaceous conductive material having a fiber diameter of 0.1 nm or more and 50 nm or less.

The electrode according to the eighth aspect can decrease the electrode resistance and thereby can increase the discharge voltage of a battery including the electrode.

According to a ninth aspect, for example, in the electrode according to any one of the first to eighth aspects, the coating film may have a thickness of 1 nm or more and 500 nm or less.

The electrode according to the ninth aspect can decrease the electrode resistance and thereby can increase the discharge voltage of a battery including the electrode.

A battery according to the tenth aspect of the present disclosure includes:
a positive electrode;
a negative electrode; and
an electrolyte layer positioned between the positive electrode and the negative electrode, wherein
at least one selected from the group consisting of the positive electrode and the negative electrode is the electrode according to any one of the first to ninth aspects, and
the electrolyte layer includes a solid electrolyte.

Since the battery according to the tenth aspect can increase the discharge voltage, the battery according to the tenth aspect can have excellent charge and discharge characteristics.

According to an eleventh aspect, for example, in the battery according to the tenth aspect, the electrolyte layer may include a first electrolyte layer and a second electrolyte layer disposed between the first electrolyte layer and the negative electrode.

The battery according to the eleventh aspect can suppress oxidation of a solid electrolyte included in the second electrolyte layer owing to the first electrolyte layer. Therefore, the battery according to the eleventh aspect can further enhance the charge and discharge characteristics of the battery.

A conductive nanoparticle according to the twelfth aspect of the present disclosure includes:
a carbonaceous conductive material; and
a coating film coating a surface of the carbonaceous conductive material, wherein
the coating film includes a conductive polymer.

When used, for example, as a conductive additive in an electrode, the conductive nanoparticle according to the twelfth aspect can enhance the ionic conductivity of the electrode and thereby can decrease the electrode resistance.

Embodiments of the present disclosure will be described hereinafter with reference to the drawings.

### Embodiment 1

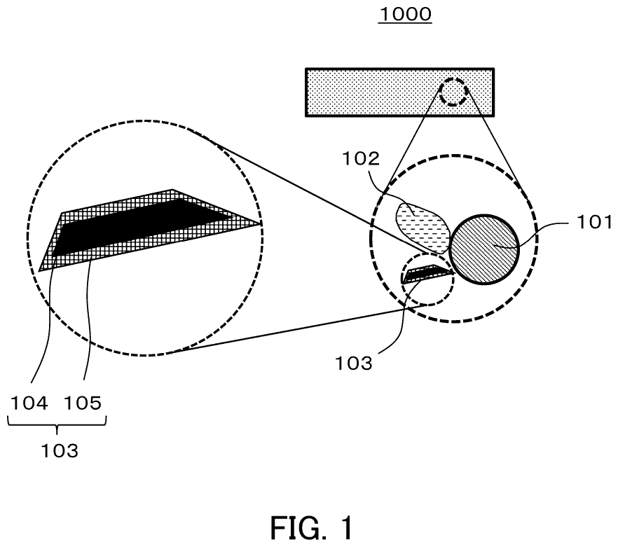

FIG. 1 is a cross-sectional view showing an electrode 1000 according to Embodiment 1. The electrode 1000 according to Embodiment 1 includes an electrode active material 101, a solid electrolyte 102, and a conductive additive 103. The conductive additive 103 includes a carbonaceous conductive material 104 and a coating film 105 coating a surface of the carbonaceous conductive material 104. The coating film 105 includes a conductive polymer.

In the electrode 1000 according to Embodiment 1, the conductive additive 103 includes the carbonaceous conductive material 104 and the coating film 105 including the conductive polymer and coating the surface of the carbonaceous conductive material 104. The electrode 1000 according to Embodiment 1 including the conductive additive 103 having this configuration can decrease the electrode resistance. That is, the electrode 1000 according to Embodiment 1 has a configuration suitable for reducing the electrode resistance. Since the electrode 1000 according to Embodiment 1 can decrease the electrode resistance, the electrode 1000 according to Embodiment 1 can increase the discharge voltage of a battery. In FIG. 1, the coating film 105 coats the entire surface of the carbonaceous conductive material 104; however, in the electrode 1000 according to Embodiment 1, the surface of the carbonaceous conductive material 104 is not necessarily coated completely with the coating film 105. That is, the surface of the carbonaceous conductive material 104 may have a portion not coated with the coating film 105.

In the electrode 1000, the electrode active material 101, the solid electrolyte 102, and the conductive additive 103 may be in contact with each other. The electrode 1000 may include a plurality of particles of the electrode active material 101, a plurality of particles of the solid electrolyte 102, and a plurality of particles or fibers of the conductive additive 103.

The electrode 1000 can be used, for example, as an electrode for all-solid-state battery. The electrode 1000 may be used as a positive electrode or a negative electrode.

Each constituent of the electrode 1000 will be described hereinafter in more details.

### [Conductive Additive 103]

As described above, the conductive additive 103 includes the carbonaceous conductive material 104 and the coating film 105 coating the surface of the carbonaceous conductive material 104.

The coating film 105 includes the conductive polymer. The coating film 105 may be substantially formed of the conductive polymer. Saying that “the coating film 105 is substantially formed of the conductive polymer” means that a proportion of the conductive polymer in the coating film 105 is 60 mass % or more. The proportion of the conductive polymer in the coating film 105 may be 80 mass % or more. The coating film 105 may consist of the conductive polymer.

The conductive polymer may include, for example, a π-conjugated conductive polymer and a polyanion. The polyanion has, for example, at least one selected from the group consisting of a monosubstituted sulfate ester group, a monosubstituted phosphate ester group, a phosphate group, a carboxy group, and a sulfo group.

The conductive polymer having the above configuration has semiconductor-like properties by itself. Therefore, the coating film 105 including the conductive polymer having the above configuration inhibits the side reaction involving electron exchange at the interface between the conductive additive 103 and the solid electrolyte 102 while maintaining the electron conductivity. Moreover, the conductive polymer having the above configuration functions as a binder and binds the particles or fibers of the conductive additive 103 to each other to extend an electron conduction path, and consequently reduces the resistance of the electrode. Hence, according to the above configuration, a new low-resistance electrode for all-solid-state batteries can be provided.

The π-conjugated conductive polymer in the conductive polymer included in the coating film 105 may include a homopolymer and/or a copolymer of at least one polymerizable compound selected from the group consisting of a thiophene, a pyrrole, an indole, a carbazole, an aniline, an acetylene, a furan, a paraphenylene vinylene, an azulene, a paraphenylene, a paraphenylene sulfide, an isothianaphthene, and a thiazyl. The polyanion may include at least one selected from the group consisting of polyvinyl sulfonic acid, polystyrene sulfonic acid, polyallyl sulfonic acid, polyethyl acrylate sulfonic acid, polybutyl acrylate sulfonic acid, poly-2-acrylamido-2-methylpropanesulfonic acid, polyisoprene sulfonic acid, polyvinyl carboxylic acid, polystyrene carboxylic acid, polyallyl carboxylic acid, polyacrylic carboxylic acid, polymethacryl carboxylic acid, poly-2-acrylamide-2-methylpropanecarboxylic acid, polyisoprene carboxylic acid, and polyacrylic acid.

The coating film 105 including the conductive polymer having the above configuration can further enhance the ionic conductivity of the electrode 1000.

The above conductive polymer of the electrode 1000 according to Embodiment 1 may include an anion other than a sulfo group. The substituted group of the anion is, for example, a monosubstituted sulfate ester group, a monosubstituted phosphate ester group, a phosphate group, or a carboxy group. In this case, the ionic conductivity of the electrode 1000 can further be enhanced.

In the above conductive polymer of the electrode 1000 according to Embodiment 1, the π-conjugated conductive polymer may include a homopolymer and/or a copolymer of at least one polymerizable compound selected from the group consisting of thiophene and a thiophene derivative, and the polyanion may include at least one selected from the group consisting of polyvinyl sulfonic acid, polystyrene sulfonic acid, polyallyl sulfonic acid, polyethyl acrylate sulfonic acid, polybutyl acrylate sulfonic acid, poly-2-acrylamido-2-methylpropanesulfonic acid, and polyisoprene sulfonic acid.

For example, a conductive polymer PEDOT-PSS including poly(3,4-ethylenedioxythiophene) (PEDOT) as the π-conjugated conductive polymer and polystyrene sulfonic acid (PSS) as the polyanion may be used as the above conductive polymer of the electrode 1000 according to Embodiment 1. The resistance of the electrode 1000 can further be decreased by using the coating film 105 including the conductive polymer PEDOT-PSS.

The molecular weight of the above conductive polymer of the electrode 1000 according to Embodiment 1 is not limited. The weight-average molecular weight of the π-conjugated conductive polymer and that of the polyanion may each be 5,000 or more and 100,000 or less, 100,000 or more and 1,000,000 or less, or 1,000,000 or more and 20,000,000 or less. In this case, the ionic conductivity of the electrode 1000 can further be enhanced.

The conductive polymer of the electrode 1000 according to Embodiment 1 may include, as the π-conjugated conductive polymer, two or more π-conjugated conductive polymers different from each other. Additionally, the conductive polymer may include, as the polyanion, two or more polyanions different from each other. In these cases, the resistance of the electrode 1000 can be reduced further.

The shape of the carbonaceous conductive material 104 is not limited to a particular shape. The carbonaceous conductive material 104 may be fibrous or particulate.

The carbonaceous conductive material 104 may include a fibrous carbonaceous conductive material. The carbonaceous conductive material 104 may be the fibrous carbonaceous conductive material. The conductive additive 103 including the fibrous carbonaceous conductive material can further decrease the resistance of the electrode 1000. The fibrous carbonaceous conductive material may be, for example, a carbon nanofiber or a carbon nanotube (CNT). For example, VGCF, which stands for vapor-grown carbon fiber, may be used as the fibrous carbonaceous conductive material. VGCF is a registered trademark of SHOWA DENKO K.K.

The carbonaceous conductive material 104 may include, for example, a fibrous carbonaceous conductive material having a fiber diameter of 0.1 nm or more and 200 nm or less.

The carbonaceous conductive material 104 may include a first fibrous carbonaceous conductive material having a fiber diameter of 80 nm or more and 200 nm or less.

The carbonaceous conductive material 104 may include a second fibrous carbonaceous conductive material having a fiber diameter of 0.1 nm or more and 50 nm or less.

The carbonaceous conductive material 104 may include both the first fibrous carbonaceous conductive material and the second fibrous carbonaceous conductive material.

The fiber diameter of the carbonaceous conductive material 104 can be measured using a cross section of the carbonaceous conductive material 104 in a scanning electron microscope (SEM) image of a cross section of the electrode 1000.

The coating film 105 may have a thickness of 1 nm or more and 500 nm or less. The thickness of the coating film 105 can be measured using a cross section of the carbonaceous conductive material 104 in a SEM image of a cross section of the electrode 1000.

In other words, the material that can be used as the conductive additive 103 is a conductive nanoparticle including a carbonaceous conductive material and a coating film coating a surface of the carbonaceous conductive material, and the coating film of the conductive nanoparticle includes a conductive polymer. The conductive nanoparticle may be fibrous or particulate.

### <Method for Manufacturing Conductive Additive 103>

The conductive additive 103, in which the coating film 105 is on the surface of the carbonaceous conductive material 104, can be manufactured, for example, by the following method.

A conductive polymer solution is prepared in which the conductive polymer is dissolved in a solvent or is dispersed in a dispersion medium. This conductive polymer solution is mixed with the carbonaceous conductive material. The concentration of the conductive polymer in the conductive polymer solution and the amount of the conductive polymer solution added to the carbonaceous conductive material are adjusted so that the coating film will be formed with an intended thickness on the surface of the carbonaceous conductive material. For example, dichlorobenzene, nitromethane, or propylene carbonate can be used as the solvent of the conductive polymer solution. Additionally, for example, water can be used as the dispersion medium of the conductive polymer solution.

The solution mixture containing the conductive polymer solution and the carbonaceous conductive material is dried. The drying may be performed, for example, at 60° C. or higher and 150° C. or lower for one hour or longer. If there is a concern about a side reaction possibly caused by remaining water, firing in a vacuum environment may be performed.

The conductive additive 103 used for manufacturing of the electrode 1000 according to Embodiment 1 can be obtained in this manner.

### [Electrode Active Material 101]

When the electrode 1000 according to Embodiment 1 is used as a positive electrode, the electrode active material 101 is a positive electrode active material.

When the electrode active material 101 is a positive electrode active material, the positive electrode active material includes a material having properties of occluding and releasing metal ions. The metal ions are typically lithium ions.

Examples of the positive electrode active material include a lithium-containing transition metal oxide, a transition metal fluoride, a polyanion material, a fluorinated polyanion material, a transition metal sulfide, a transition metal oxysulfide, and a transition metal oxynitride. Examples of the lithium-containing transition metal oxide include Li(Ni,Co,Al)O₂, Li(Ni,Co,Mn)O₂, and LiCoO₂.

In the present disclosure, an expression, for example, “(Ni,Co,Al)” in a formula refers to at least one element selected from the group of elements in the parentheses. In other words, “(Ni,Co,Al)” is synonymous with the expression “at least one selected from the group consisting of Ni, Co, and Al”. The same applies to other elements.

The positive electrode active material may have a median diameter of 0.1 μm or more and 100 μm or less. When the positive electrode active material has a median diameter of 0.1 μm or more, the positive electrode active material and the solid electrolyte 102 are in a favorable dispersion state in the positive electrode. That enhances the charge and discharge characteristics of a battery including this positive electrode. When the positive electrode active material has a median diameter of 100 μm or less, the lithium diffusion rate in the positive electrode active material is increased. Therefore, a battery including this positive electrode can operate at high power.

The median diameter of the positive electrode active material may be larger than that of the solid electrolyte 102. In this case, the positive electrode active material and the solid electrolyte 102 are in a favorable dispersion state in the positive electrode.

Herein, the median diameter means a particle size (volume average particle size) at cumulative volume of 50% in a volume-based particle size distribution measured by laser diffraction-scattering.

In the positive electrode, a ratio of a volume of the positive electrode active material to the sum of the volume of the positive electrode active material and that of the solid electrolyte 102 may be 0.30 or more and 0.95 or less. In this case, the energy density and the output of a battery including this positive electrode increase.

A coating layer may be formed on at least a portion of the surface of the positive electrode active material. The coating layer can be formed on the surface of the positive electrode active material, for example, before the conductive additive and a binder are mixed. A coating material included in the coating layer is, for example, a sulfide solid electrolyte, an oxide solid electrolyte, or a halide solid electrolyte. An increase of an overvoltage of a battery including the positive electrode can be suppressed by suppressing oxidative decomposition of the solid electrolyte 102 by means of the coating layer of the positive electrode active material.

The positive electrode may have a thickness of 10 μm or more and 500 μm or less. In this case, the energy density and the output of a battery including this positive electrode increase.

When the electrode 1000 according to Embodiment 1 is used as a negative electrode, the electrode active material 101 is a negative electrode active material.

When the electrode active material 101 is a negative electrode active material, the negative electrode active material includes a material having properties of occluding and releasing metal ions. The metal ions are typically lithium ions.

Examples of the negative electrode active material include a metal material, a carbon material, an oxide, a nitride, a tin compound, and a silicon compound. The metal material may be a simple substance of a metal or may be an alloy. Examples of the metal material include lithium metal and a lithium alloy. Examples of the carbon material include natural graphite, coke, semi-graphitized carbon, a carbon fiber, spherical carbon, artificial graphite, and amorphous carbon. In terms of the capacity density, the negative electrode active material is suitably, for example, silicon (namely, Si), tin (namely, Sn), a silicon compound, or a tin compound.

The negative electrode active material may be selected taking account of the reduction resistance of the solid electrolyte 102 included in the negative electrode. For example, when the negative electrode includes a solid electrolyte consisting of a halide as the solid electrolyte 102, the negative electrode active material may be a material having properties of occluding and releasing lithium ions at 0.27 V or more versus lithium. Examples of such a negative electrode active material include a titanium oxide, indium metal, and a lithium alloy. Examples of the titanium oxide include Li₄Ti₅O₁₂, LiTi₂O₄, and TiO₂. Reductive decomposition of the solid electrolyte material included in the negative electrode can be suppressed by using such a negative electrode active material. Consequently, the charge and discharge characteristics of a battery including the negative electrode can be enhanced.

The negative electrode active material may have a median diameter of 0.1 μm or more and 100 μm or less. When the negative electrode active material has a median diameter of 0.1 μm or more, the negative electrode active material and the solid electrolyte 102 are in a favorable dispersion state in the negative electrode. That enhances the charge and discharge characteristics of a battery including this negative electrode. When the negative electrode active material has a median diameter of 100 μm or less, the lithium diffusion rate in the negative electrode active material is increased. Therefore, a battery including this negative electrode can operate at high power.

The median diameter of the negative electrode active material may be larger than that of the solid electrolyte 102. In this case, the negative electrode active material and the solid electrolyte 102 are in a favorable dispersion state in the negative electrode.

In the negative electrode, a ratio of a volume of the negative electrode active material to the sum of the volume of the negative electrode active material and that of the solid electrolyte 102 may be 0.30 or more and 0.95 or less. In this case, the energy density and the output of a battery including this negative electrode increase.

### [Solid Electrolyte 102]

The solid electrolyte 102 is a solid electrolyte having metal ion conductivity. The metal ions are typically lithium ions.

The solid electrolyte 102 may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, and Li₆PS₅Cl. Moreover, LiX, Li₂O, MO_{q}, LiₚMO_{q}, or the like may be added thereto. Here, X is at least one element selected from the group consisting of F, Cl, Br, and I. The symbol M is at least one element selected from the group consisting of P, Si, Ge, B, Al, Ga, In, Fe, and Zn. The symbols p and q are each independently a natural number. One sulfide solid electrolyte selected from the above materials or two or more of sulfide solid electrolytes selected from the above materials can be used.

The solid electrolyte 102 may be an oxide solid electrolyte.

The oxide solid electrolyte can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, LiGeO₄ and element-substituted substances thereof; a garnet solid electrolyte typified by Li₇La₃Zr₂O₁₂ and element-substituted substances thereof; Li₃PO₄ and N-substituted substances thereof; or a glass or glass ceramic that includes a Li—B—O compound, such as LiBO₂ or Li₃BO₃, as a base and to which Li₂SO₄, Li₂CO₃, or the like is added. One oxide solid electrolyte selected from the above materials or two or more of oxide solid electrolytes selected from the above materials can be used.

The solid electrolyte 102 may be a halide solid electrolyte.

Examples of the halide solid electrolyte include Li₂MgX₄, Li₂FeX₄, Li(Al,Ga,In)X₄, Li₃(Al,Ga,In)X₆, and LiI. Here, X is at least one selected from the group consisting of F, Cl, Br, and I.

Another example of the halide solid electrolyte is a compound represented by LiₐMe_{b}Y_{c}X₆. Here, a+mb+3c=6 and c>0 are satisfied. The symbol Me is at least one element selected from the group consisting of metalloid elements and metal elements other than Li and Y. The symbol m represents the valence of Me.

In the present disclosure, the metalloid elements are B, Si, Ge, As, Sb, and Te. The metal elements are all the elements (except hydrogen) included in Groups 1 to 12 of the periodic table and all the elements (except B, Si, Ge, As, Sb, Te, C, N, P, O, S, and Se) included in Groups 13 to 16 of the periodic table. That is, the metalloid elements and the metal elements refer to a group of elements that can become cations when forming an inorganic compound with a halogen compound.

To increase the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb. The halide solid electrolyte may be Li₃YCl₆ or Li₃YBr₆.

The solid electrolyte 102 may be a polymer solid electrolyte.

For example, a compound of a polymer compound and a lithium salt can be used as the polymer solid electrolyte. The polymer compound may have an ethylene oxide structure. The polymer compound having an ethylene oxide structure can contain a large amount of the lithium salt. Therefore, the ionic conductivity can further be enhanced. The lithium salt can be LiPF₆, LiBF₄, LiSbF₆, LiAsF₆, LiSO₃CF₃, LIN(SO₂CF₃)₂, LIN(SO₂C₂F₅)₂, LiN(SO₂CF₃)(SO₂C₄F₉), LiC(SO₂CF₃)₃, or the like. One lithium salt selected from the examples of the lithium salt can be used alone. Alternatively, a mixture of two or more lithium salts selected from the examples of the lithium salt can be used.

The electrode 1000 may include a non-aqueous electrolyte solution, a gel electrolyte, or an ionic liquid in order to facilitate exchange of metal ions (e.g., lithium ions) and enhance the output properties of a battery including the electrode 1000.

The non-aqueous electrolyte solution contains a non-aqueous solvent and a lithium salt dissolved in the non-aqueous solvent.

Examples of the non-aqueous solvent include a cyclic carbonate solvent, a chain carbonate solvent, a cyclic ether solvent, a chain ether solvent, a cyclic ester solvent, a chain ester solvent, and a fluorinated solvent. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethyl methyl carbonate, and fluorodimethylene carbonate.

One non-aqueous solvent selected from these may be used alone. Alternatively, a mixture of two or more non-aqueous solvents selected from these may be used.

Examples of the lithium salt include LiPF₆, LiBF₄, LiSbF₆, LiAsF₆, LiSO₃CF₃, LIN(SO₂CF₃)₂, LIN(SO₂C₂F₅)₂, LIN(SO₂CF₃)(SO₂C₄F₉), and LiC(SO₂CF₃)₃. One lithium salt selected from these may be used alone. Alternatively, a mixture of two or more lithium salts selected from these may be used.

The lithium salt concentration is, for example, 0.5 mol/L or more and 2 mol/L or less.

A polymer material impregnated with the non-aqueous electrolyte solution can be used as the gel electrolyte. Examples of the polymer material include polyethylene oxide, polyacrylonitrile, polyvinylidene fluoride, polymethylmethacrylate, and a polymer having an ethylene oxide bond.

Examples of the cation included in the ionic liquid include:
(i) aliphatic chain quaternary salts such as tetraalkylammonium and tetraalkylphosphonium;
(ii) aliphatic cyclic ammoniums such as pyrrolidiniums, morpholiniums, imidazoliniums, tetrahydropyrimidiniums, piperaziniums, and piperidiniums; and
(iii) nitrogen-containing heterocyclic aromatic cations such as pyridiniums and imidazoliums.

Examples of the anion included in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻. The ionic liquid may contain a lithium salt.

The electrode 1000 may include a binder so as to improve the adhesion between the particles.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethyl cellulose. A copolymer can also be used as the binder. Such a binder is, for example, a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from the above materials may also be used as the binder.

The electrode 1000 may further include an additional conductive additive made of a material different from that of the conductive additive 103 to further reduce the resistance. The additional conductive additive can be, for example: graphite, such as natural graphite or artificial graphite; carbon black, such as acetylene black or Ketjenblack; a conductive fiber, such as a carbon fiber or a metal fiber; carbon fluoride; a metal powder, such as aluminum powder; a conductive whisker, such as a zinc oxide whisker or a potassium titanate whisker; a conductive metal oxide, such as titanium oxide; or a conductive polymer compound, such as polyaniline, polypyrrole, or polythiophene. Using a conductive carbon additive as the conductive additive can seek cost reduction.

The method for manufacturing the electrode 1000 according to Embodiment 1 is, for example, a method in which a dispersion including the materials of the electrode 1000 is prepared and is then applied to a substrate (e.g. a current collector). Examples of the application method include die coating, gravure coating, doctor blade coating, bar coating, spray coating, and electrostatic coating.

### Embodiment 2

Embodiment 2 will be hereinafter described. A description overlapping with that of Embodiment 1 is omitted as appropriate.

A battery according to Embodiment 2 includes a positive electrode, a negative electrode, and an electrolyte layer. The electrolyte layer is positioned between the positive electrode and the negative electrode. At least one selected from the group consisting of the positive electrode and the negative electrode has the same configuration as that of the electrode 1000 according to Embodiment 1. That is, at least one selected from the group consisting of the positive electrode and the negative electrode includes a conductive additive including a carbonaceous conductive material and a coating film including a conductive polymer and coating a surface of the carbonaceous conductive material. The electrolyte layer includes a solid electrolyte.

Since including the positive electrode and/or the negative electrode having the same configuration as the electrode according to Embodiment 1, the battery according to Embodiment 2 can have excellent charge and discharge characteristics. Specifically, the battery according to Embodiment 2 can have a high discharge voltage.

The battery according to Embodiment 2 may be an all-solid-state battery. The all-solid-state battery may be a primary battery or a secondary battery.

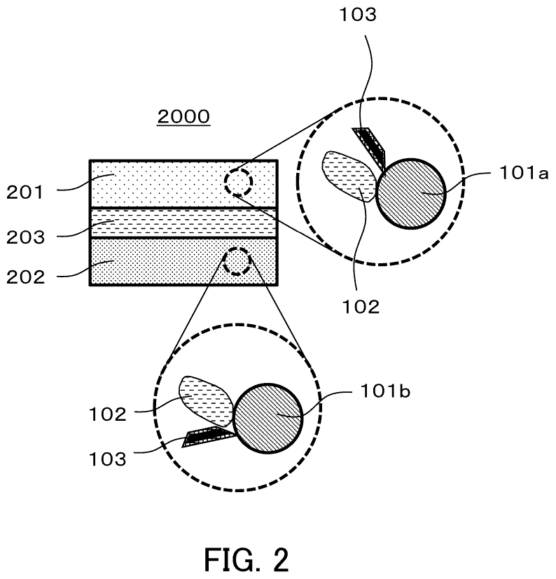

FIG. 2 is a cross-sectional view showing a battery 2000 according to Embodiment 2.

The battery 2000 includes a positive electrode 201, an electrolyte layer 203, and a negative electrode 202. The electrolyte layer 203 is disposed between the positive electrode 201 and the negative electrode 202. In the present embodiment, the electrolyte layer 203 is in contact with the positive electrode 201 and the negative electrode 202.

In one example of the battery 2000 shown in FIG. 2, both the positive electrode 201 and the negative electrode 202 have the same configuration as that of the electrode 1000 according to Embodiment 1. However, the battery 2000 according to Embodiment 2 is not limited to this exemplary configuration, and either the positive electrode 201 or the negative electrode 202 alone may have the same configuration as that of the electrode 1000 according to Embodiment 1.

The positive electrode 201 includes a positive electrode active material 101a, the solid electrolyte 102, and the conductive additive 103. The positive electrode active material 101a corresponds to the positive electrode active material described as the electrode active material 101 in Embodiment 1. Moreover, the solid electrolyte 102 and the conductive additive 103 included in the positive electrode 201 are respectively the solid electrolyte 102 and the conductive additive 103 included in the electrode 1000 described in Embodiment 1. Therefore, detailed descriptions of the positive electrode active material 101a, the solid electrolyte 102, and the conductive additive 103 of the positive electrode 201 are omitted here.

The negative electrode 202 includes a negative electrode active material 101b, the solid electrolyte 102, and the conductive additive 103. The negative electrode active material 101b corresponds to the negative electrode active material described as the electrode active material 101 in Embodiment 1. Moreover, the solid electrolyte 102 and the conductive additive 103 included in the negative electrode 202 are respectively the solid electrolyte 102 and the conductive additive 103 included in the electrode 1000 described in Embodiment 1. Therefore, detailed descriptions of the negative electrode active material 101b, the solid electrolyte 102, and the conductive additive 103 of the negative electrode 202 are omitted here.

The electrolyte layer 203 includes a solid electrolyte. Examples of the solid electrolyte included in the electrolyte layer 203 include a sulfide solid electrolyte, an oxide solid electrolyte, and a halide solid electrolyte. The sulfide solid electrolyte, the oxide solid electrolyte, and the halide solid electrolyte that can be included in the electrolyte layer 203 are respectively the same as the sulfide solid electrolyte, the oxide solid electrolyte, and the halide solid electrolyte that can be included in the solid electrolyte 102 of the electrode 1000 described in Embodiment 1. Therefore, detailed descriptions of the sulfide solid electrolyte, the oxide solid electrolyte, and the halide solid electrolyte that can be included in the electrolyte layer 203 are omitted here.

The electrolyte layer 203 may have a thickness of 1 μm or more and 1000 μm or less. In this case, the energy density and the output of the battery 2000 increase.

The positive electrode 201, the negative electrode 202, and the electrolyte layer 203 may include different solid electrolytes from each other so as to increase the ion conductivity, the chemical stability, and the electrochemical stability.

The positive electrode 201, the negative electrode 202, and the electrolyte layer 203 may include a non-aqueous electrolyte solution, a gel electrolyte, or an ionic liquid in order to facilitate exchange of metal ions (e.g., lithium ions) and enhance the output properties of the battery 2000. The non-aqueous electrolyte solution, the gel electrolyte, and the ionic liquid included in the battery 2000 are respectively the same as the non-aqueous electrolyte solution, the gel electrolyte, and the ionic liquid described in Embodiment 1. Therefore, detailed descriptions of the non-aqueous electrolyte solution, the gel electrolyte, and the ionic liquid are omitted here.

At least one selected from the group consisting of the positive electrode 201, the negative electrode 202, and the electrolyte layer 203 may include a binder so as to improve the adhesion between the particles. The binder included in the battery 2000 is the same as the binder described in Embodiment 1. Therefore, a detailed description of the binder is omitted here.

The shape of the battery 2000 according to Embodiment 2 is, for example, a coin type, a cylindrical type, a prismatic type, a sheet type, a button type, a flat type, or a stack type.

### <Battery Manufacturing Method>

The battery 2000 according to Embodiment 2 may be manufactured, for example, by preparing materials for formation of the positive electrode, the electrolyte layer, and the negative electrode and then producing by a known method a multilayer body in which the positive electrode 201, the electrolyte layer 203, and the negative electrode 202 are disposed in this order.

### Embodiment 3

Embodiment 3 will be hereinafter described. A description overlapping with those of Embodiments 1 and 2 is omitted as appropriate.

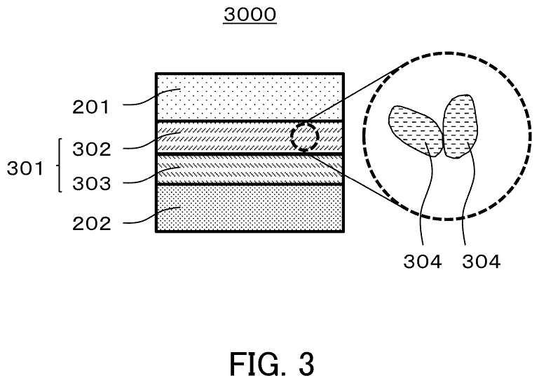

FIG. 3 is a cross-sectional view schematically showing a configuration of a battery 3000 according to Embodiment 3.

The battery 3000 includes the positive electrode 201, the negative electrode 202, and an electrolyte layer 301. The electrolyte layer 301 is disposed between the positive electrode 201 and the negative electrode 202. The electrolyte layer 301 includes a first electrolyte layer 302 and a second electrolyte layer 303. The first electrolyte layer 302 is disposed between the positive electrode 201 and the negative electrode 202. The second electrolyte layer 303 is disposed between the first electrolyte layer 302 and the negative electrode 202. The first electrolyte layer 302 includes a solid electrolyte 304.

When a solid electrolyte material having high oxidation resistance is used as the solid electrolyte 304, oxidation of a solid electrolyte included in the second electrolyte layer 303 can be suppressed owing to the first electrolyte layer 302. Consequently, the battery 3000 can have further enhanced charge and discharge characteristics.

The first electrolyte layer 302 may include a plurality of particles of the solid electrolyte 304. In the first electrolyte layer 302, the plurality of particles of the solid electrolyte 304 may be in contact with each other.

In the battery 3000, the solid electrolyte included in the second electrolyte layer 303 may have a reduction potential lower than that of the solid electrolyte 304 included in the first electrolyte layer 302. In this case, reduction of the solid electrolyte 304 included in the first electrolyte layer 302 can be suppressed. Consequently, the battery 3000 can have enhanced charge and discharge characteristics. For example, when the first electrolyte layer 302 includes a halide solid electrolyte as the solid electrolyte 304, the second electrolyte layer 303 may include a sulfide solid electrolyte to suppress reduction decomposition of the halide solid electrolyte.

### EXAMPLES

Hereinafter, details of the present disclosure will be described with reference to an example and a comparative example.

### Example 1

[Coating of Carbonaceous Conductive Material with Conductive Polymer]

VGCF-H (manufactured by SHOWA DENKO K.K.) and poly(3,4-ethylenedioxythiophene)-poly(styrenesulfonate) (manufactured by Sigma-Aldrich Co., LLC.; 3.0-4.0% aqueous solution; high-conductivity grade)) were used respectively as a carbonaceous conductive material and a conductive polymer. An amount of 0.1 g of VGCF-H was weighed out. The specific surface area of VGCF-H is 13 m²/g. Taking this into account, the aqueous poly(3,4-ethylenedioxythiophene)-poly(styrenesulfonate) solution was added so that a coating film formed of the conductive polymer would have a thickness of 7 nm. Furthermore, 2 cc of pure water was added to the resulting mixture, which was then dried under heating at 80° C. with a magnetic stirrer. After that, a vacuum drying treatment was performed at 80° C. for 12 hours. A powder of a conductive additive according to Example 1 including a carbonaceous conductive material having a surface coated with a conductive polymer was obtained in this manner.

### [Production of Battery]

In an argon atmosphere, LiNi_{0.6}Co_{0.2}Mn_{0.2}O₂ being a positive electrode active material of Example 1 and Li₃YCl₆ being a solid electrolyte of Example 1 were prepared at a volume ratio of LiNi_{0.6}Co_{0.2}Mn_{0.2}O₂:Li₃YCl₆=45:55. Furthermore, the conductive additive of Example 1 in an amount of 3 mass % was added thereto, and these materials were mixed in an agate mortar. A positive electrode mixture was obtained in this manner.

In an argon atmosphere, LiTiO₂ being a negative electrode active material of Example 1 and Li₃YB₃Cl₃ being a solid electrolyte of Example 1 were prepared at a volume ratio of LiTiO₂:Li₃YB₃Cl₃=40:60. Furthermore, the conductive additive of Example 1 in an amount of 1 mass % was added thereto, and these materials were mixed in an agate mortar. A negative electrode mixture was obtained in this manner.

The positive electrode mixture (21.7 mg), a solid electrolyte material (120 mg), and the negative electrode mixture (32.6 mg) were layered in this order in an insulating cylinder having an inner diameter of 9.5 mm. As the solid electrolyte material was used Li₃YB₃Cl₃. A 300 MPa pressure was applied to the resulting multilayer body. A positive electrode, an electrolyte layer, and a negative electrode were formed in this manner.

Next, current collectors made of stainless steel were attached to the positive electrode and the negative electrode, and a current collector lead was attached to each of the current collectors.

Finally, an insulating ferrule was used to isolate the inside of the insulating cylinder from the outside atmosphere and hermetically seal the cylinder. A battery of Example 1 was obtained in this manner.

### Comparative Example

### [Production of Battery]

A carbonaceous conductive material (VGCF-H (manufactured by SHOWA DENKO K.K.)) not coated with a conductive polymer was used as a conductive additive of a positive electrode. Except for this, a battery of Comparative Example was produced in the same manner as in Example.

### (Measurement of Electrode Resistance)

Each of the batteries of Example and Comparative Example was connected to a potentiostat (VSP-300 manufactured by BioLogic) equipped with a frequency response analyzer. The positive electrode current collector was connected to a working electrode and a potential measuring terminal. The negative electrode current collector was connected to a counter electrode and a reference electrode. The impedance was measured at room temperature (25° C.) by an electrochemical impedance measurement method.

The electrode resistance shown in Table 1 is a numerical value obtained by subtracting a resistance proportionate to the thickness of the electrolyte layer from a real number value assumed to be an electrode resistance value, the real number value of the impedance at a measurement point where the absolute value of a phase of a complex impedance was smallest in a Nyquist plot obtained by impedance measurement for each of Example and Comparative Example.

### (Low-Temperature Charge-Discharge Test)

A charge-discharge test was performed under the following conditions for each of the batteries of Example and Comparative Example to measure a pulse discharge voltage in an initial state.

First, the battery was placed in a constant-temperature chamber at 25° C., and was then charged at a current density of 0.17 mA/cm² until the positive electrode reached a voltage of 2.7 V relative to the negative electrode. This current density corresponds to 0.05 C rate with respect to a theoretical capacity of the battery.

Next, the battery was placed in a constant-temperature chamber at −40° C., and was discharged for one second at a current density of 0.44 mA/cm². This current density corresponds to 0.13 C rate with respect to the theoretical capacity of the battery. Table 1 shows a discharge voltage one second after the beginning of the discharging.

### (Cycle Test)

A charge-discharge test was performed under the following conditions for the batteries of Example and Comparative Example to 70 cycles.

First, the battery was placed in a constant-temperature chamber at 25° C., and was charged at a current density of 0.17 mA/cm² until the positive electrode reached a voltage of 2.7 V relative to the negative electrode. This current density corresponds to 0.05 C rate with respect to the theoretical capacity of the battery.

Then, the battery was discharged at a current density of 0.17 mA/cm² until the negative electrode reached a voltage of 0.9 V relative to the positive electrode. This current density corresponds to 0.05 C rate with respect to the theoretical capacity of the battery. This charge-discharge cycle was repeated three times.

Next, the battery was charged at a current density of 1.02 mA/cm² until the positive electrode reached a voltage of 2.7 V relative to the negative electrode. Reaching a voltage of 2.7 V was followed by constant-voltage charge at 2.7 V to charge the battery until the current density became 0.17 mA/cm². After that, the battery was discharged at a current density of 1.02 mA/cm² until the negative electrode reached a voltage of 0.9 V relative to the positive electrode. The current density during the constant-current discharge corresponds to 0.3 C rate with respect to the theoretical capacity of the current density. This charge-discharge cycle was repeated ten times.

Afterwards, one cycle of charge and discharge at a current density corresponding to 0.05 C rate was inserted every ten cycles of the above charge and discharge at a current density corresponding to 0.3 C rate. The charge-discharge cycles were repeated until the total charge-discharge cycle count reached 70 cycles.

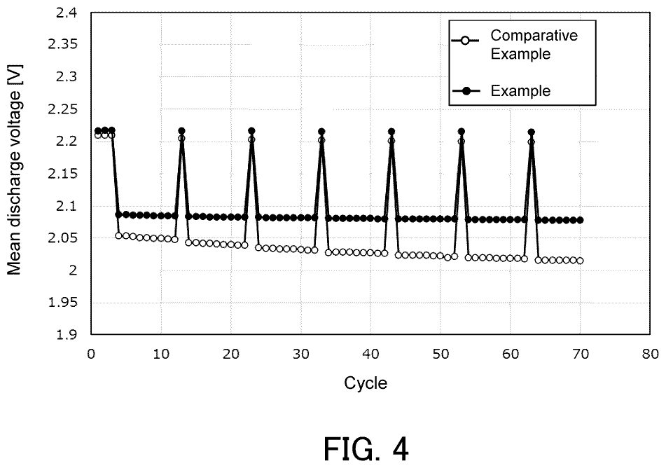

FIG. 4 is a graph showing charge-discharge cycle characteristics of the batteries of Example and Comparative Example. That is, FIG. 4 is a graph showing the results of the cycle test for the batteries of Example and Comparative Example in a constant-temperature chamber at 25° C. In FIG. 4, the vertical axis indicates a mean discharge voltage, and the horizontal axis indicates the cycle count. The term “mean discharge voltage” refers to a voltage at a point where the total discharged energy (i.e., a cumulative value of products of discharge voltage and electric capacitance) becomes ½. According to the results of the cycle test, the battery of Example exhibited a higher discharge voltage than that of Comparative Example, and showed a small reduction in voltage.

TABLE 1

| | | | Pulse | |
|---|---|---|---|---|
| | | | discharge | Discharge |
| | Carbonaceous | Electrode | voltage | voltage |
| | conductive | resistance | at −40° | at 25° C. |
| | additive | [Ω] | C. [V] | at 70^{th} cycle [V] |
| Comparative | VGCF (not | 2102.31 | 1.57 | 2.015 |
| Example | coated with | | | |
| | PEDOT-PSS) | | | |
| Example | PEDOT-PSS- | 1120.16 | 1.72 | 2.078 |
| | coated VGCF | | | |

### DISCUSSION

As is obvious from the results for Example and Comparative Example, as for the battery including, as an electrode, the carbonaceous conductive material VGCF-H (manufactured by SHOWA DENKO K.K.) coated with the conductive polymer poly(3,4-ethylenedioxythiophene)-poly(styrenesulfonate), the electrode resistance reduced and an increase in discharge voltage was confirmed by the low-temperature pulse test and the cycle charge-discharge test. This is attributable to exhibition of the electrode resistance reducing effect achieved by using the carbonaceous conductive material coated with the conductive polymer as a conductive additive.

Similar effects can be achieved by using other conductive polymers. It is inferred that a similar effect can be exhibited by coating a carbonaceous conductive material with a material having semiconductor-like properties.

As shown above by Example, the present disclosure can provide a new electrode material reducing the electrode resistance and having a high discharge voltage.

### INDUSTRIAL APPLICABILITY

The battery of the present disclosure can be used, for example, as an all-solid-state lithium-ion secondary battery.

What is claimed is:

1. An electrode comprising:
an electrode active material;
a solid electrolyte; and
a conductive additive, wherein
the conductive additive comprises a carbonaceous conductive material and a coating film coating a surface of the carbonaceous conductive material, and
the coating film comprises a conductive polymer.

2. The electrode according to claim 1, wherein the conductive polymer comprises: a π-conjugated conductive polymer; and a polyanion having at least one selected from the group consisting of a monosubstituted sulfate ester group, a monosubstituted phosphate ester group, a phosphate group, a carboxy group, and a sulfo group.

3. The electrode according to claim 2, wherein
the π-conjugated conductive polymer comprises a homopolymer and/or a copolymer of at least one polymerizable compound selected from the group consisting of a thiophene, a pyrrole, an indole, a carbazole, an aniline, an acetylene, a furan, a paraphenylene vinylene, an azulene, a paraphenylene, a paraphenylene sulfide, an isothianaphthene, and a thiazyl, and
the polyanion comprises at least one selected from the group consisting of polyvinyl sulfonic acid, polystyrene sulfonic acid, polyallyl sulfonic acid, polyethyl acrylate sulfonic acid, polybutyl acrylate sulfonic acid, poly-2-acrylamido-2-methylpropanesulfonic acid, polyisoprene sulfonic acid, polyvinyl carboxylic acid, polystyrene carboxylic acid, polyallyl carboxylic acid, polyacrylic carboxylic acid, polymethacryl carboxylic acid, poly-2-acrylamide-2-methylpropanecarboxylic acid, polyisoprene carboxylic acid, and polyacrylic acid.

4. The electrode according to claim 3, wherein
the π-conjugated conductive polymer comprises a homopolymer and/or a copolymer of at least one polymerizable compound selected from the group consisting of thiophene and a thiophene derivative, and
the polyanion comprises at least one selected from the group consisting of polyvinyl sulfonic acid, polystyrene sulfonic acid, polyallyl sulfonic acid, polyethyl acrylate sulfonic acid, polybutyl acrylate sulfonic acid, poly-2-acrylamido-2-methylpropanesulfonic acid, and polyisoprene sulfonic acid.

5. The electrode according to claim 1, wherein the carbonaceous conductive material comprises a fibrous carbonaceous conductive material.

6. The electrode according to claim 5, wherein the carbonaceous conductive material comprises a fibrous carbonaceous conductive material having a fiber diameter of 0.1 nm or more and 200 nm or less.

7. The electrode according to claim 6, wherein the fibrous carbonaceous conductive material comprises a first fibrous carbonaceous conductive material having a fiber diameter of 80 nm or more and 200 nm or less.

8. The electrode according to claim 6, wherein the fibrous carbonaceous conductive material comprises a second fibrous carbonaceous conductive material having a fiber diameter of 0.1 nm or more and 50 nm or less.

9. The electrode according to claim 1, wherein the coating film has a thickness of 1 nm or more and 500 nm or less.

10. A battery comprising:
a positive electrode;
a negative electrode; and
an electrolyte layer positioned between the positive electrode and the negative electrode, wherein
at least one selected from the group consisting of the positive electrode and the negative electrode is the electrode according to claim 1, and
the electrolyte layer comprises a solid electrolyte.

11. The battery according to claim 10, wherein the electrolyte layer comprises a first electrolyte layer and a second electrolyte layer disposed between the first electrolyte layer and the negative electrode.

12. A conductive nanoparticle comprising:
a carbonaceous conductive material; and
a coating film coating a surface of the carbonaceous conductive material, wherein
the coating film comprises a conductive polymer.
